(19) United States
(12) Patent Application Publication
(10) Pub. No.: US 2015/0356070 A1
(43) Pub. Date: Dec. 10, 2015

(54) INFORMATION PROCESSING DEVICE, INFORMATION PROCESSING METHOD, AND NON-TRANSITORY COMPUTER-READABLE MEDIUM

(71) Applicant: FUJI XEROX CO., LTD., Tokyo (JP)

(72) Inventor: Kimiyoshi ARAI, Kanagawa (JP)

(73) Assignee: FUJI XEROX CO., LTD., Tokyo (JP)

(21) Appl. No.: 14/666,868

(22) Filed: Mar. 24, 2015

(30) Foreign Application Priority Data
Jun. 6, 2014 (JP) 2014-117655

(51) Int. Cl. G06F 17/24

(52) U.S. Cl. CPC G06F 17/248

(57) ABSTRACT

An information processing device includes a receiving unit, a computing unit, and a presenting unit. The receiving unit receives first information related to creation or distribution of a first document to be created used a template. The computing unit computes a degree of overlap between the first information and second information related to creation or distribution of a second document that was created using a template, the second information being extracted from storage that stores the second information. The presenting unit presents the degree of overlap computed by the computing unit in association with a template for creating the first document.

### CROSS-REFERENCE TO RELATED APPLICATIONS

This application is based on and claims priority under 35 USC 119 from Japanese Patent Application No. 2014-117655 filed Jun. 6, 2014.

### BACKGROUND

The present invention relates to an information processing device, an information processing method, and a non-transitory computer-readable medium.

### SUMMARY

According to an aspect of the invention, there is provided an information processing device that includes a receiving unit, a computing unit, and a presenting unit. The receiving unit receives first information related to creation or distribution of a first document to be created used a template. The computing unit computes a degree of overlap between the first information and second information related to creation or distribution of a second document that was created using a template, the second information being extracted from storage that stores the second information. The presenting unit presents the degree of overlap computed by the computing unit in association with a template for creating the first document.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is an explanatory diagram illustrating an exemplary system configuration that realizes an exemplary embodiment;

FIG. 3 is a flowchart illustrating an exemplary process according to an exemplary embodiment;

FIG. 4 is a flowchart illustrating an exemplary process according to an exemplary embodiment;

FIG. 5 is a flowchart illustrating an exemplary process according to an exemplary embodiment;

FIG. 6 is a flowchart illustrating an exemplary process according to an exemplary embodiment;

FIG. 7 is an explanatory diagram illustrating an exemplary data structure of a degree of overlap determination table;

FIG. 8 is an explanatory diagram illustrating an exemplary process according to an exemplary embodiment (for the example of presenting a degree of overlap display screen);

FIG. 9 is an explanatory diagram illustrating an exemplary process according to an exemplary embodiment (for the example of presenting a template display screen);

FIG. 10 is an explanatory diagram illustrating an exemplary process according to an exemplary embodiment (for the example of presenting a template display screen); and

FIG. 11 is a block diagram illustrating an exemplary hardware configuration of a computer that realizes an exemplary embodiment.

### DETAILED DESCRIPTION

First, before describing the exemplary embodiment, presupposed technology will be described. Note that this description is intended to aid comprehension of the exemplary embodiment.

Documents are being created by using templates. For example, multiple templates are prepared in advance on a server or the like accessible via communication. The server is accessible from multiple user terminals. A user terminal accesses the server, and uses a template to create a document.

Note that a template refers to a model of a document.

Elements that are editable and elements that are not editable are specified in advance, and the document creator creates a document by editing only the elements that are editable. By creating a document from a model, it is possible to create a customized document while still following brand rules and document creation rules (for example, a certain field may allow only vertical writing, and disallow horizontal writing).

When creating a document using a template, using the same template may sometimes result in a similar document. For example, when creating an advertising document, it is typical to avoid creating the same kind of advertising document as another company.

With a judgment that uses a user identification (ID), a business sector to which the user belongs, an ID of a destination of the created document, and a rivalry list to determine similarity, a document may be determined to be similar in some cases, even though there is a low possibility of the recipient actually perceiving a similarity.

Also, when a similarity judgment result is expressed as a binary (Yes/No) value, the user may be unable to make an appropriate judgment, and the selection options may be overly restricted.

Also, when handling a template designed with a large editable element, there is a possibility that edited documents may differ greatly from one another. Conversely, there is a possibility that edited documents may become similar to each other, even if the original templates are different. Consequently, a similarity check among just the original templates may be unsuitable to judge the similarity of finished documents.

Note that a document herein refers to an object made up of text data generally, and in some cases electronic data such as graphics, images, video, and audio (also called files), or a combination of the above. A document is an object that may be stored, edited, searched, or the like, and exchanged in individual units between systems or users, and encompasses object similar to the above. Specifically, the term “document” includes documents, web pages, and the like created by the exemplary embodiment.

Hereinafter, an exemplary embodiment related to realizing the present invention will be described by way of example on the basis of the drawings.

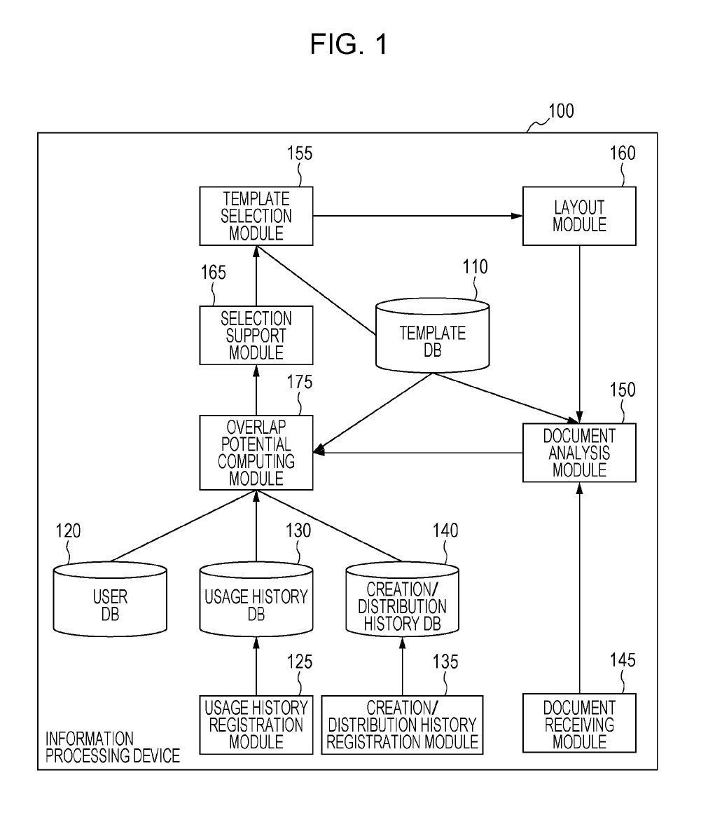

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

An information processing device 100 according to the exemplary embodiment creates a document using a template, and as illustrated by the example of FIG. 1, includes a template database (DB) 110, a user DB 120, a usage history registration module 125, a usage history DB 130, a creation/distribution history registration module 135, a creation/distribution history DB 140, a document receiving module 145, a document analysis module 150, a template selection module 155, a layout module 160, a selection support module 165, and an overlap potential computing module 175.

The template DB 110 is connected to the document analysis module 150, the template selection module 155, and the overlap potential computing module 175. The template DB 110 stores templates, is accessed from the document analysis module 150, the template selection module 155, and the overlap potential computing module 175, and hands over templates. The stored templates are generally templates for creating advertising documents, but are not limited thereto.

The user DB 120 is connected to the overlap potential computing module 175. The user DB 120 stores information related to users who have rights to create a document using a template in the template DB 110. The user DB 120 is accessed by the overlap potential computing module 175, and hands over the above information. The user-related information may include a user ID, a name, an address, a telephone number, a company name, an age, and a gender, for example.

The usage history registration module 125 is connected to the usage history DB 130. The usage history registration module 125 registers a template usage history (log) in the usage history DB 130. The template usage history may include a template selection history and an edit history, for example. These histories are collected as a log every time a process related to the relevant template is conducted, and information such as the time when a selection or an edit was made is collected. The time may be the year, month, day, hour, minute, second, fraction of a second, or some combination thereof.

The usage history DB 130 is connected to the usage history registration module 125 and the overlap potential computing module 175. The usage history DB 130 stores template usage histories collected by the usage history registration module 125, is accessed from the overlap potential computing module 175, and hands over these usage histories.

The creation/distribution history registration module 135 is connected to the creation/distribution history DB 140. The creation/distribution history registration module 135 registers, in the creation/distribution history DB 140, a history related to the creation or distribution of a document created using a template. The history may be anything related to the creation or distribution of a document created using a template, and may be, for example, the time when the document was created or distributed, the place where the document was distributed, the target that the document appeals to, the distribution size of the document, the distribution channel of the document, or a combination of two or more of the above. This information may be obtained as a result of a manager inputting information collected about a document, or alternatively, if the distributed document is an electronic document, the information may be information collected as a log every time the electronic document is distributed. Herein, “the target that the document appeals to” is typically called the target, and refers to the target to which a product, service, or the like is marketed. The document is an advertisement, promotion, or the like, and has a role of encouraging consumers to purchase a product or service.

The creation/distribution history DB 140 is connected to the creation/distribution history registration module 135 and the overlap potential computing module 175. The creation/distribution history DB 140 stores histories related to the creation or distribution of a document registered by the creation/distribution history registration module 135, is accessed from the overlap potential computing module 175, and hands over these histories.

The template selection module 155 is connected to the template DB 110, the layout module 160, and the selection support module 165. The user conducts a selection operation on the basis of a presentation by the selection support module 165, and the template selection module 155 selects a template in the template DB 110 according to the selection operation. Subsequently, the selected template is handed over to the layout module 160.

The document receiving module 145 is connected to the document analysis module 150. The document receiving module 145 receives an already-distributed document, and hands over the document to the document analysis module 150. The document is a document created using a template in the template DB 110.

The layout module 160 is connected to the document analysis module 150 and the template selection module 155. The layout module 160 uses a template selected by the template selection module 155 to create a document according to operations by a user. The created document is handed over to the document analysis module 150.

The document analysis module 150 is connected to the template DB 110, the document receiving module 145, the layout module 160, and the overlap potential computing module 175. The document analysis module 150 analyzes a document handed over from the layout module 160 or the document receiving module 145. For example, the document analysis module 150 extracts information such as a document element, the position of the element, the number of characters in the document, character strings (words and the like obtained by morphological analysis), the taste of the document, and the color palette. Subsequently, an extraction result is handed over to the overlap potential computing module 175.

The overlap potential computing module 175 is connected to the template DB 110, the user DB 120, the usage history DB 130, the creation/distribution history DB 140, the document analysis module 150, and the selection support module 165. The overlap potential computing module 175 receives first information related to the creation or distribution of a first document to create using a template. Note that the first document herein is a document that is about to be created. Herein, “receiving” may mean loading information that is predetermined for each template, for example, or accepting information generated as a result of operations performed using a device such as keyboard, mouse, or touch panel by a user who is attempting to create the first document using a template.

Subsequently, the overlap potential computing module 175 computes a degree of overlap between the first information, and second information related to the creation or distribution of a second document that was created using a template, which is extracted from the creation/distribution history DB 140 that stores the second information. Note that the second document herein is a document that has already been created. Consequently, the overlap potential computing module 175 computes a degree of overlap between information related to a document that is about to be created, and information related to a document that has already been created.

For example, the first information may be a first time at which to create or distribute the first document, while the second information may be a second time at which the second document was created or distributed. Subsequently, the overlap potential computing module 175 may compute a higher degree of overlap to the extent that the first time and the second time are close to each other. For the computation at this point, a predetermined computational formula, a predetermined condition table (a table associating combinations of times and degrees of overlap for those combinations), or the like may be used. Specifically, the reciprocal of the number of days between the first time and the second time may be used. In addition, the degree of overlap may not be merely the length of a period of time, but may also be computed according to whether or not the month is the same (such as a high degree of overlap for the same month as last year, for example), or whether or not the season is the same (such as a high degree of overlap between July and August in the summer, and a low degree of overlap between July in the summer and February in the winter).

As another example, the first information may be a first place at which to distribute the first document, while the second information may be a second place at which the second document was distributed. Subsequently, the overlap potential computing module 175 may compute a higher degree of overlap to the extent that the distance between the first place and the second place is short. For the computation at this point, a predetermined computational formula, a predetermined condition table (a table associating combinations of places and degrees of overlap for those combinations), or the like may be used. Specifically, the reciprocal of the distance between the first place and the second place may be used. Also, the degree of overlap may not be merely the length of a distance, but may also be computed according to whether or not the places lie on the same railway line (such as a high degree of overlap between neighboring stations on the same railway line, for example).

As another example, the first information may be a first target that the first document appeals to, while the second information may be a second target that the second document appeals to. Subsequently, the overlap potential computing module 175 may compute a higher degree of overlap to the extent that the first target and the second target are similar to each other. For the computation at this point, a predetermined computational formula, a predetermined condition table (a table associating combinations of targets and degrees of overlap for those combinations), or the like may be used. Specifically, the reciprocal of the difference between the age of the first target and the age of the second target may be used. Also, the degree of overlap may not be merely the length of an age difference, but may also be computed according to whether or not the gender is the same, or according to the business sector of the company to which the target belongs (such as a high degree of overlap for the same business sector, for example).

As another example, the first information may be a distribution size of the first document, while the second information may be a distribution size of the second document. Note that in the case of an electronic document, the distribution size may be a quantity such as a number of presentations, a number of clicks, a number of visits, a number of page views, or a number of downloads. Subsequently, the overlap potential computing module 175 may compute a higher degree of overlap to the extent that the distribution size of the first document or the distribution size of the second document is large. For the computation at this point, a predetermined computational formula, a predetermined condition table (a table associating distribution sizes and degrees of overlap for those distribution sizes), or the like may be used. Specifically, a formula in which the degree of overlap increases in proportion to either distribution size is acceptable. Also, a predetermined degree of overlap may be set when the distribution size is within a predetermined range.

As another example, the first information may be a distribution channel of the first document, while the second information may be a distribution channel of the second document. Subsequently, the overlap potential computing module 175 may compute a higher degree of overlap to the extent that the distribution channel of the first document and the distribution channel of the second document are similar to each other. For the computation at this point, a predetermined condition table (a table associating combinations of distribution channels and degrees of overlap for those combinations) or the like may be used. Specifically, the degree of overlap may be computed according to the combination of types of distribution channels (such as a low degree of overlap between a flyer (paper) distribution channel and a banner ad on the Internet, and a high degree of overlap with a social networking service (SNS) on the Internet).

As another example, the overlap potential computing module 175 may also compute a degree of overlap by additionally using a similarity between the created first document and the second document. The similarity computation may use established technology. For example, a similarity may be computed by using factors included in the analysis result from the document analysis module 150, such as the type of an element in a document (such as a text box or graphic box), the position of such an element, the number of characters in the document, and character strings (such as words). Also, the similarity may be between a template to be used to create the first document, and the template that was used to create the second document.

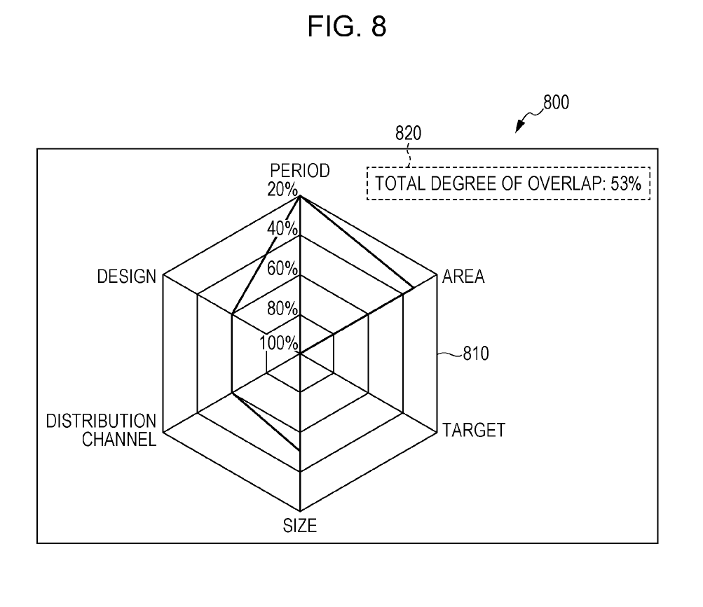

The selection support module 165 is connected to the template selection module 155 and the overlap potential computing module 175. The selection support module 165 presents a degree of overlap computed by the overlap potential computing module 175, in association with a template for creating the first document. To make user judgment easier, a multi-valued degree of overlap is illustrated on a map. For example, as a presentation example, (1) “Distribution period interval: medium, Geographical distance: low, Total degree of overlap: low” may be presented, (2) “x points are being used within the range of a xx % degree of overlap” may be presented, or (3) the above may be illustrated on a map, and degrees of overlap may be presented as concentric circles. Specific examples will be discussed later using FIGS. 8, 9, and 10. Note that the term “presentation” includes actions such as displaying information on a display device such as a liquid crystal display, outputting information to an output device such as a speaker, or a combination of the above.

Additionally, the selection support module 165 may also be configured to present a template or distribution method whose degree of overlap computed by the overlap potential computing module 175 is less than a predetermined threshold value.

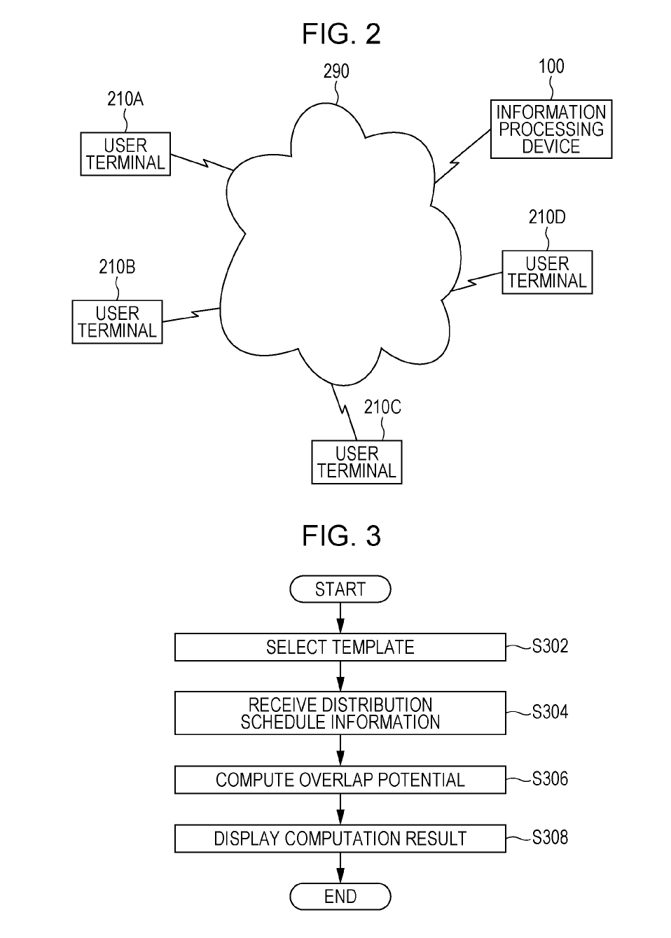

FIG. 2 is an explanatory diagram illustrating an exemplary system configuration that realizes the exemplary embodiment.

An information processing device 100, a user terminal 210A, a user terminal 210B, a user terminal 210C, and a user terminal 210D are interconnected via a communication network 290. The communication network 290 may be wireless, wired, or a combination of the two, and may use the Internet or the like as a communication infrastructure, for example. The information processing device 100 is used from each of the user terminals 210. For example, a browser is used to access a template in the information processing device 100, and a document is created. A user terminal 210 may be a device such as a PC, or a mobile device such as a mobile phone (including a smartphone), insofar as communication with the information processing device 100 is possible.

FIG. 3 is a flowchart illustrating an exemplary process according to the exemplary embodiment. Specifically, FIG. 3 is a flowchart for displaying the degree of overlap with a selected template.

In step S302, the template selection module 155 selects a template. Specifically, the template selection module 155 selects a template to evaluate for use from among a list of templates, according to a user operation.

In step S304, the overlap potential computing module 175 receives distribution schedule information. Specifically, the overlap potential computing module 175 receives information related to a distribution schedule (such as a period, area, target, distribution size, and distribution channel), according to a user operation. Note that the order of steps S302 and S304 may also be reversed.

In step S306, the overlap potential computing module 175 computes the overlap potential, which is the degree of overlap.

In step S308, the selection support module 165 displays the computed result. For example, a display is presented like in FIG. 8 discussed later. Note that since a document has not been created yet, the displayed graph does not include the design criterion.

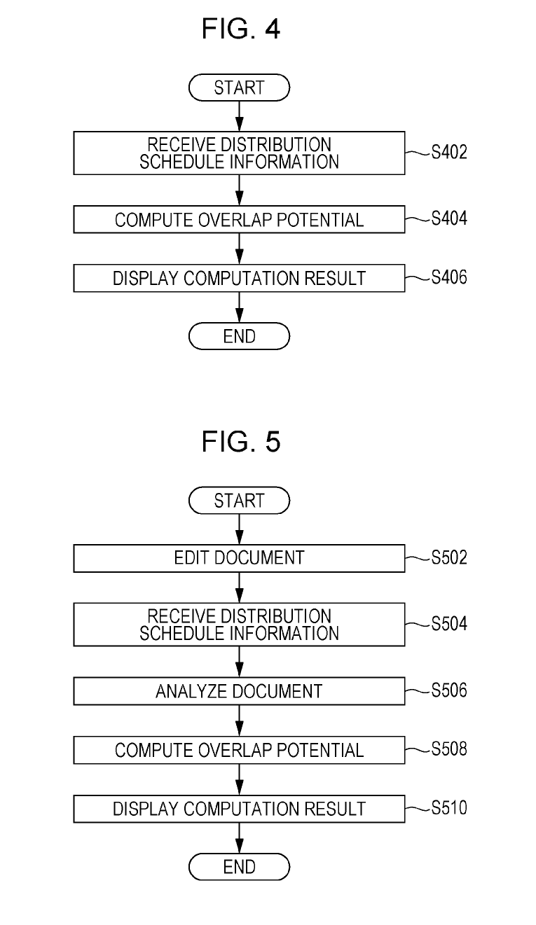

FIG. 4 is a flowchart illustrating an exemplary process according to the exemplary embodiment. Specifically, FIG. 4 is a flowchart for collectively displaying degrees of overlap in a list of templates.

In step S402, the overlap potential computing module 175 receives distribution schedule information. Specifically, the overlap potential computing module 175 receives information related to a distribution schedule (such as a period, area, target, distribution size, and distribution channel), according to a user operation.

In step S404, the overlap potential computing module 175 computes the overlap potential, which is the degree of overlap.

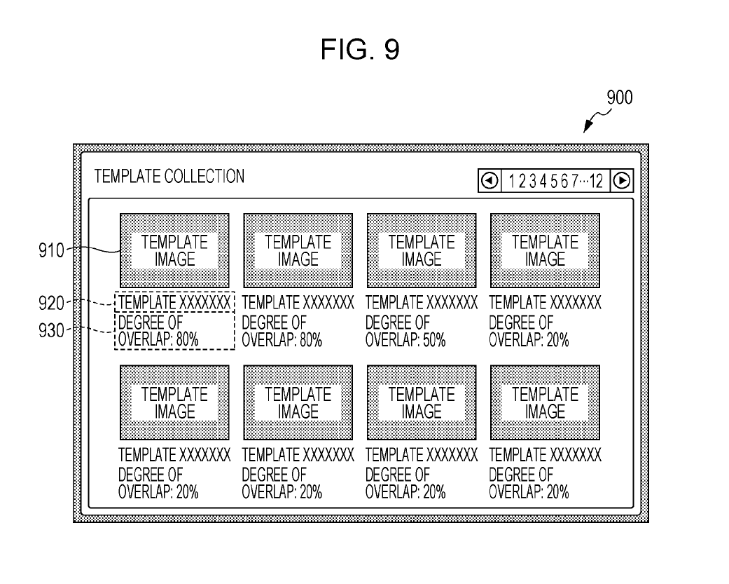

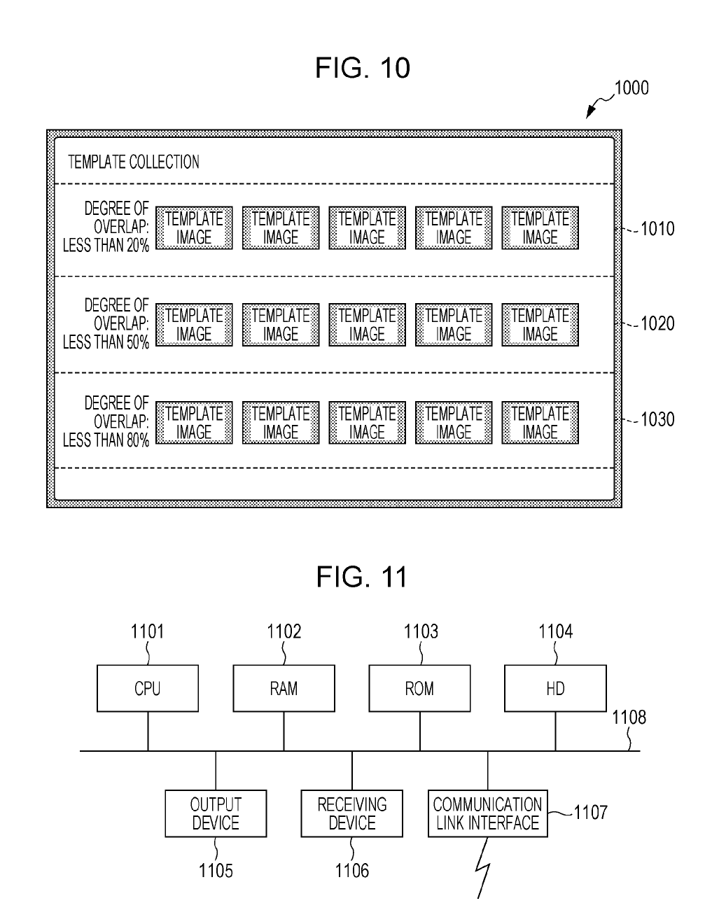

In step S406, the selection support module 165 displays the computed result. For example, a display is presented like in FIG. 9 or 10 discussed later.

FIG. 5 is a flowchart illustrating an exemplary process according to the exemplary embodiment. Specifically, FIG. 3 is a flowchart for displaying the degree of overlap for an edited document.

In step S502, the layout module 160 edits a document. Specifically, the layout module 160 selects a template to evaluate for use from among a list of templates and edits the template as an individual document, according to a user operation.

In step S504, the overlap potential computing module 175 receives distribution schedule information. Specifically, the overlap potential computing module 175 receives information related to a distribution schedule (such as a period, area, target, distribution size, and distribution channel), according to a user operation. Note that the order of steps S502 and S504 may also be reversed.

In step S506, the document analysis module 150 analyzes the document.

In step S508, the overlap potential computing module 175 computes the overlap potential, which is the degree of overlap.

In step S510, the selection support module 165 displays the computed result. For example, a display is presented like in FIG. 8 discussed later.

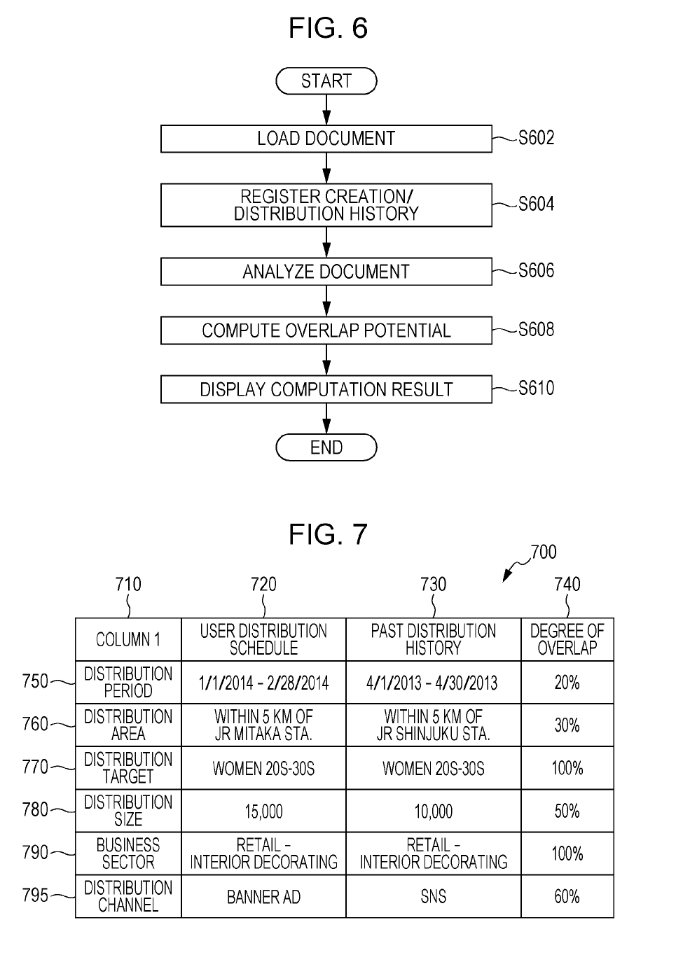

FIG. 6 is a flowchart illustrating an exemplary process according to the exemplary embodiment. Specifically, FIG. 6 is a flowchart for loading a document and distribution data externally, and displaying the degree of overlap.

In step S602, the document receiving module 145 loads a document. Specifically, a document is loaded according to a user operation.

In step S604, the creation/distribution history registration module 135 registers entries in the creation and distribution histories. Specifically, the creation history and distribution history of the document are loaded according to a user operation.

In step S606, the document analysis module 150 analyzes the document. Note that this presupposes that the processing in steps S502 and S504 in the flowchart illustrated by the example of FIG. 5 has finished before the processing in step S606.

In step S608, the overlap potential computing module 175 computes the overlap potential, which is the degree of overlap.

In step S610, the selection support module 165 displays the computed result. For example, a display is presented like in FIG. 8 discussed later.

FIG. 7 is an explanatory diagram illustrating an exemplary data structure of a degree of overlap determination table 700. The degree of overlap determination table 700 is generated as a processing result of the overlap potential computing module 175. Note that the information in the user distribution schedule field 720 is information that the overlap potential computing module 175 receives by a user operation, while the information in the past distribution history field 730 is information that is extracted from the creation/distribution history DB 140, and the information in the degree of overlap field 740 is a computation result from the overlap potential computing module 175.

The degree of overlap determination table 700 includes, in the column direction, a column 1 field 710, a user distribution schedule field 720, a past distribution history field 730, and a degree of overlap field 740, and in the row direction, a distribution period field 750, a distribution area field 760, a distribution target field 770, a distribution size field 780, a business sector field 790, and a distribution channel field 795.

The user distribution schedule field 720 stores a user's distribution schedule (a distribution schedule for the first document). The past distribution history field 730 stores a past distribution history (a distribution history of the second document). The degree of overlap field 740 stores the degree of overlap between the first document and the second document computed by the overlap potential computing module 175.

The distribution period field 750 stores a distribution period of the relevant document. The distribution area field 760 stores a distribution area of the relevant document. The distribution target field 770 stores a distribution target of the relevant document. The distribution size field 780 stores a distribution size of the relevant document. The business sector field 790 stores a business sector in which the relevant document is used. The distribution channel field 795 stores a distribution channel of the relevant document.

FIG. 8 is an explanatory diagram illustrating an exemplary process according to an exemplary embodiment (for the example of presenting a degree of overlap display screen 800). On the degree of overlap display screen 800, a degree of overlap display graph 810 and a total degree of overlap display area 820 are displayed. The degree of overlap display graph 810 displays a graph (radar chart) of the respective information in the degree of overlap field 740 of the degree of overlap determination table 700. Note that the design axis indicates a similarity of design between a created first document (or a template used to create the first document) and a second document to be compared against. An analysis result from the document analysis module 150 is used.

The total degree of overlap display area 820 displays a statistical value (such as the mean, mode, or median, for example) of the degrees of overlap (including similarity) for each criterion.

FIG. 9 is an explanatory diagram illustrating an exemplary process according to the exemplary embodiment (for the example of displaying a template display screen 900). On the template display screen 900, a template image display area 910, a template name display area 920, and a degree of overlap display area 930 are displayed for each template. In the template image display area 910, a thumbnail image (reduced image) of a template image is displayed. In the template name display area 920, the name of the relevant template is displayed. In the degree of overlap display area 930, the degree of overlap between the relevant template and a past document is displayed.

FIG. 10 is an explanatory diagram illustrating an exemplary process according to an exemplary embodiment (for the example of displaying a template display screen 1000). On the template display screen 1000, a “Degree of overlap: less than 20%” template display area 1010, a “Degree of overlap: less than 50%” template display area 1020, and a “Degree of overlap: less than 80%” template display area 1030 for different degrees of overlap. In the “Degree of overlap: less than 20%” template display area 1010, a template group with a degree of overlap that is less than 20% is displayed. In the “Degree of overlap: less than 50%” template display area 1020, a template group with a degree of overlap that is at least 20% but less than 50% is displayed. In the “Degree of overlap: less than 80%” template display area 1030, a template group with a degree of overlap that is at least 50% but less than 80% is displayed.

Note that a hardware configuration of a computer executing a program that acts as the present exemplary embodiment is a general computer as illustrated by the example of FIG. 11, and specifically is a computer or the like that may be a personal computer or a server. In other words, as a specific example, a CPU 1101 is used as a processing unit (computational unit), while RAM 1102, ROM 1103, and an HD 1104 are used as storage devices. For the HD 1104, a hard disk or a solid-state drive (SSD) may be used, for example. The computer is made up of the CPU 1101 that executes programs such as the usage history registration module 125, the creation/distribution history registration module 135, the document receiving module 145, the document analysis module 150, the template selection module 155, the layout module 160, the selection support module 165, and the overlap potential computing module 175, the RAM 1102 that stores such programs and data, the ROM 1103 that stores programs and the like for activating the computer, the HD 1104 which is an auxiliary storage device (and which may also be flash memory or the like), a receiving device 1106 that receives data on the basis of user operations with respect to a keyboard, mouse, touch panel, or the like, an image output device 1105 such as a CRT or liquid crystal display, a communication link interface 1107 such as a network interface card for connecting to a communication network, and a bus 1108 for joining and exchanging data with the above components. Multiple such computers may also be connected to each other by a network.

Of the foregoing exemplary embodiments, for those made up of a computer program, software in the form of a computer program is made to be read into a system with the above hardware configuration, and the foregoing exemplary embodiments are realized by the cooperative action of the software and hardware resources.

Note that the hardware configuration illustrated in FIG. 11 illustrates a single exemplary configuration, and that the exemplary embodiment is not limited to the configuration illustrated in FIG. 11 insofar as the configuration still enables execution of the modules described in the exemplary embodiment. For example, some modules may also be realized with special-purpose hardware (such as an ASIC, for example), and some modules may be configured to reside within an external system and be connected via a communication link. Furthermore, it may also be configured such that multiple instances of the system illustrated in FIG. 11 are connected to each other by a communication link and operate in conjunction with each other. Additionally, besides a personal computer in particular, an exemplary embodiment may also be incorporated into a device such as an information appliance, photocopier, fax machine, scanner, printer, or multi-function device (that is, an image processing device having two or more from among scanning, printing, copying, and faxing functions).

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

The recording medium may be a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), or a Secure Digital (SD) memory card, for example.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being modulated onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a receiving unit that receives first information related to creation or distribution of a first document to be created used a template;
a computing unit that computes a degree of overlap between the first information and second information related to creation or distribution of a second document that was created using a template, the second information being extracted from storage that stores the second information; and
a presenting unit that presents the degree of overlap computed by the computing unit in association with a template for creating the first document.

2. The information processing device according to claim 1, wherein
the first information is a first time at which to create or distribute the first document, and the second information is a second time at which the second document was created or distributed, and
the computing unit computes a higher degree of overlap to an extent that the first time and the second time are close to each other.

3. The information processing device according to claim 1, wherein
the first information is a first place at which to distribute the first document, and the second information is a second place at which the second document was distributed, and
the computing unit computes a higher degree of overlap to an extent that a distance between the first place and the second place is short.

4. The information processing device according to claim 1, wherein
the first information is a first target that the first document appeals to, and the second information is a second target that the second document appeals to, and
the computing unit computes a higher degree of overlap to an extent that the first target and the second target are similar to each other.

5. The information processing device according to claim 1, wherein
the first information is a distribution size of the first document, and the second information is a distribution size of the second document, and
the computing unit computes a higher degree of overlap to an extent that the distribution size of the first document or the distribution size of the second document is large.

6. The information processing device according to claim 1, wherein
the first information is a distribution channel of the first document, and the second information is a distribution channel of the second document, and
the computing unit computes a higher degree of overlap to an extent that the distribution channel of the first document and the distribution channel of the second document are similar to each other.

7. The information processing device according to claim 1, wherein
the computing unit computes a degree of overlap by additionally using a similarity between the created first document and the second document.

8. The information processing device according to claim 1, further comprising:
a second presenting unit that presents a template or a distribution method whose degree of overlap computed by the computing unit is lower than a predetermined threshold value.

9. An information processing method comprising:
receiving first information related to creation or distribution of a first document to be created used a template;
computing a degree of overlap between the first information and second information related to creation or distribution of a second document that was created using a template, the second information being extracted from storage that stores the second information; and
presenting the computed degree of overlap in association with a template for creating the first document.

10. A non-transitory computer readable medium storing a program causing a computer to execute a process for processing information, the process comprising:
receiving first information related to creation or distribution of a first document to be created used a template;
computing a degree of overlap between the first information and second information related to creation or distribution of a second document that was created using a template, the second information being extracted from storage that stores the second information; and
presenting the computed degree of overlap in association with a template for creating the first document.
